(19) United States
(12) Patent Application Publication
(10) Pub. No.: US 2014/0317993 A1
(43) Pub. Date: Oct. 30, 2014

(54) ELECTRIC DETERRENT DEVICE WITH VOIDS AND FLAPS

(71) Applicant: Bird Barrier America, Inc., Carson, CA (US)

(72) Inventor: CAMERON A. RIDDELL, Carson, CA (US)

(21) Appl. No.: 14/259,058

(22) Filed: Apr. 22, 2014

Related U.S. Application Data
(60) Provisional application No. 61/816,122, filed on Apr. 25, 2013.

(51) Int. Cl. A01M 29/24

(52) U.S. Cl. CPC A01M 29/24
USPC 43/98

(57) ABSTRACT

An electric deterrent device and methods for installing and producing an electric deterrent device for delivering an electric shock to an animal, pest, or bird to be deterred, having the typical components of a non-conductive base to which the electrically conductive elements are attached. The bottom layer unfolds outward to allow sewing of the conductive elements to the top layer of the elongated base, while preventing the stitching from penetrating the bottom layer of the elongated base. The bottom layer is then folded back into place after sewing is completed, thereby insulating any hole, fastener, or conductive element that pushed through the top layer of the elongated base from water or other material that may congregate at the bottom exterior, preventing unwanted arcing to the exterior surface below. Voids may also be included in the base of the device.

### CROSS-REFERENCE TO RELATED APPLICATION

This application claims the benefit of U.S. Provisional Application No. 61/816,122, filed Apr. 25, 2013, the entirety of which is incorporated herein by reference.

### FIELD

This patent document relates in general to an electric deterrent device that delivers an electric shock to animals or pests that come into contact with it. In particular, this patent document pertains to such devices that are adapted for use as bird deterrent devices.

### BACKGROUND

Electricity was first put to commercial and residential use in the United States in the late 1800's, to solve the age-old problem of darkness. Ever since, the ability of electrical current to deliver an electric shock to a person or animal has been recognized. Shortly thereafter, the non-lethal applications of electricity for use in encouraging the behavior of animals was commercially implemented. The electric cattle prod is perhaps the best known of those devices. Today, however, electricity is used in many ways with animals. As just a few examples, electric fences are used to keep farm animals in and predators out, and dog trainers use electrical stimulus in dog collars to assist with dog training.

An age-old problem that has been perplexing mankind since long before the discovery and harnessing of electricity is the propensity of pests in general, but particularly birds, to land in areas where their human neighbors would prefer they did not. An incredible array of devices have been used to dissuade birds from landing or roosting in areas undesirable to humans. Metallic spikes, coil or rotating devices, sound-emitting devices, imitation predators, and even real predators, are just a few examples of bird deterrent devices that have been used.

At some point in the evolution of bird deterrent devices lethal and non-lethal electrical shock began to be employed as a bird deterrent. One device of this type is shown in U.S. Pat. No. 4,299,048. In one embodiment, a pair of copper wires connected to a power source are embedded in opposite sides of a cable of appropriate diameter such that when the birds of choice (in this case, starlings) land on the cable, their feet touch both wires, closing the circuit and thereby delivering a lethal shock to the birds.

U.S. Pat. No. 6,283,064 discloses another version of a bird and pest deterrent device in which a pair of crimped copper wires are appropriately spaced apart so that the bird's or other pest's feet will touch both wires, resulting in a short circuit and delivering a shock to the bird or other pest.

Other devices for carrying electric charges for discouraging birds and other pests are described in U.S. Pat. Nos. 3,294,893; 3,366,854; 3,717,802; 4,299,048; and 5,850,808. A common idea to all of these devices is the concept of appropriately spaced-apart electrical contacts which will both be connected by the bird's (or other pest's) feet (or other part of their anatomy) so as to deliver the appropriate electric shock.

U.S. Pat. No. 7,481,021 to Riddell uses a flexible track and replaces the typically-used wire with a braided conductive element that may be sewn to the base. This configuration helps alleviate the problem of the wire separating from its base when the track is bent to fit certain surfaces.

Some other devices and methods are disclosed, for example, in the following: U.S. Pat. Nos. 8,015,747; 8,020,340; 8,286,385; U.S. Publication No. 2013/0042817; and international applications WO 95/08915; and WO 2012/040009.

While all of these devices work at least initially to a degree in some installations, the designs of the current systems exhibit problems. One problem is the unwanted shorting of the conductive wires due to an accumulation of water beneath the track or base. For example, the stitching used to secure the metal braids or metal mesh to flexible polyvinyl chloride (“PVC”) extrusions can create problems with respect to arcing to some surface materials. Occasionally, the sewing machine's needle breaks a wire strand and pushes it through the bottom of the base. When the wire is electrified these strands can arc with a wet or metal surface below. In addition, water that pools underneath the track can be absorbed by the thread used to sew the conductive wire to the base, creating a conductor and causing an arc to the surface below. Raising the stitch off the surface by means of a groove does not eliminate this problem.

While the existing animal deterrents are useful to a degree, they still suffer from certain drawbacks that may cause undesired short circuiting of the device. Therefore, there exists a need in the art for an improved electrical shock deterrent device that solves or at least alleviates some or all of these problems.

### SUMMARY OF THE EMBODIMENTS

Systems and methods for deterring animals by using electrical animal deterrent devices and systems and methods of installing and manufacturing such electric deterrent devices are disclosed and claimed herein.

As described more fully below, the apparatus and processes of the embodiments disclosed permit improved systems and methods for deterring animals by using electrical animal deterrent devices and systems and methods of installing and manufacturing such electric deterrent devices. Further aspects, objects, desirable features, and advantages of the apparatus and methods disclosed herein will be better understood and apparent to one skilled in the relevant art in view of the detailed description and drawings that follow, in which various embodiments are illustrated by way of example. It is to be expressly understood, however, that the drawings are for the purpose of illustration only and are not intended as a definition of the limits of the claimed embodiments.

To this end, an electric deterrent device is disclosed, the electric deterrent device comprising an elongated base having a cross section including a top layer with a top surface and a bottom surface, and a bottom layer; a first conductive element extending perpendicular to the cross section along the top surface of the top layer; and a first fastener that couples the first conductive element to the top surface at a first connection point and extends from the first conductive element through the top layer to a second connection point on the bottom surface of the top layer; wherein the cross section of the elongated base has a slit in an exterior surface of the elongated base such that the slit creates a flap in the bottom layer of the elongated base where the flap helps insulate the first fastener at the second connection point from moisture or bird excrement; and wherein the elongated base further comprises at least one void.

In some embodiments, the at least one void extends along the length of the elongated base. In some embodiments, the void is open at the ends of the elongated base. In some embodiments, the void is closed at the ends of the elongated base. In some embodiments, the elongated base comprises a plurality of voids extending perpendicular to the cross section of the elongated base. In some embodiments, the voids may contain an adhesive, an aerogel, or a foam.

In some embodiments, the fastener may be made of a conductive material. In some embodiments, the fastener may be iron, steel, stainless steel, copper, or zinc plated copper. In some embodiments, the sewing thread may be made of a conductive material. In some embodiments, the sewing thread may be made of iron, steel, stainless steel, copper, or zinc plated copper. In some embodiments the fastener may be made of a waterproof material, such as plastic, to prevent water-wicking. In some embodiments the sewing thread may be made of a waterproof material, such as plastic. In some embodiments, the fastener may be at least one of clamps, locking cable ties, tying a string, staples, sewing, tacs, pins, screws, nuts and bolts, cloth, linen, twine, string, tape, adhesive, or any other suitable fastener. In some embodiments, the fastener may be made of a polymer, plastic, metal, vinyl, nylon, para-aramid synthetic fiber (such as Kevlar®), polyester, ceramic, wood, cotton, wool, glue, or any other suitable material.

In some embodiments, at least a portion of a void may include a low-density material, such as a foam or aerogel. In some embodiments, the conductive element may be comprised of a single strand. In some embodiments, the conductive element may be comprised of a single strand interwoven with itself. In some embodiments, the conductive element may be comprised of a tube. In some embodiments, the conductive element may be comprised of an inner tube and an outer tube. In some embodiments, the conductive element may be comprised of a tube, wherein the tube is further comprised of a single strand. In some embodiments, the conductive element may be comprised of a tube, wherein the tube is further comprised of a single strand interwoven with itself. In some embodiments, the conductive element may be a conductive sheet. In some embodiments, the conductive element may be a conductive sheet with no free spaces. In some embodiments, the conductive element may be a conductive tube. In some embodiments, the conductive element may be a conductive rod. In some embodiments, the conductive element may be a conductive wire. In some embodiments, the conductive element may be a conductive tube with additional holes or free spaces around the tube's outer surface extending to the tube's inner surface around the tube's circumference.

In another embodiment, the bottom layer is coupled to the top layer enclosing a gap. In yet another embodiment, the cross section of the elongated base has a slit that extends from an exterior to the gap. In another embodiment, the slit is positioned such that it creates a flap in the top layer or the bottom layer, wherein the flap covers at least a portion of the gap. In some embodiments, the flap is sufficiently flexible to allow it to be folded to obtain access to a bottom surface of the top layer from an exterior.

In certain embodiments, the electric deterrent device further comprises a second conductive element coupled to the top surface of the top layer and extending parallel to the first conductive element. In another embodiment, an adhesive is disposed on a portion of the first fastener that extends into the gap. In yet another embodiment, the first conductive element is sewn to the elongated base. In another embodiment, the first fastener extends from the first conductive element through the top layer and through the bottom layer.

In some embodiments, the cross section includes a center divider connecting the top layer and the bottom layer and is located substantially in a center of the elongated base and extending substantially perpendicular to the top layer. In another embodiment, the bottom layer is coupled to the top layer by the center divider. In yet another embodiment, the first conductive element and the second conductive element are attachable respectively to the positive and negative terminals of a power source. In another embodiment, the thickness of the bottom layer increases proximate to the slit.

In some embodiments, the electric deterrent device further comprises an anchor protruding down from the bottom surface of the top layer. In another embodiment, a portion of the anchor proximate to its bottom is thicker than a portion of the anchor further from its bottom. In another embodiment, the anchor is an inverted T shape. In yet another embodiment, the anchor and the bottom layer are sealed with an adhesive. In another embodiment, further comprising an anchor protruding down from the bottom surface of the top layer, the thickness of the gap tapers down proximate to the anchor.

In another embodiment, the first fastener extends through the bottom layer to a third connection point on the bottom surface of the bottom layer.

In certain embodiments, the first conductive element is made of metal. In another embodiment, the first conductive element further comprises a braided wire. In yet another embodiment, the braided wire comprises some strands of a conductive material and other strands of a non-conductive material. In another embodiment, a gap at an end of the elongated base is sealed off from an exterior.

In some embodiments, the electric deterrent device further comprises an arc suppressor disposed between the first conductive element and the second conductive element. In another embodiment, the thickness of the top layer decreases proximate to the first fastener. In yet another embodiment, a surface area of the bottom surface of the bottom layer is increased over a substantial portion of the bottom surface of the bottom layer.

In one form, the present disclosure provides an electric deterrent device, comprising a first non-conductive piece having a top side and a bottom side a conductive element coupled to the first non-conductive piece with a first fastener that extends from the non-conductive piece to the bottom side; a second non-conductive piece coupled to the first non-conductive piece wherein the second non-conductive piece covers the first fastener and insulates the first fastener from an exterior; and wherein the first non-conductive piece further comprises a void. In some embodiments, the second non-conductive piece further comprises a void. In some embodiments, the fasteners do not extend into or enter any of the voids.

In certain embodiments, the first non-conductive piece is coupled to the second non-conductive piece by an adhesive. In another embodiment, the second non-conductive piece is coupled to the first non-conductive piece by interlocking. In yet another embodiment, the first nonconductive piece and the second non-conductive piece comprise an interlocking shape; and wherein the interlocking shape is selected from the group of a T-shape, a stemmed inverted V-shape, a stemmed inverted U-shape, a stemmed circular shape, and an arrowhead shape.

In one form, the present disclosure provides an electric deterrent device, comprising an elongated base having a gap forming a top inside surface and a bottom inside surface; a first conductive element coupled to an outside of the elongated base by a first fastener that extends through to the top inside surface; a second conductive element coupled to an outside of the elongated base by a second fastener that extends through to the top inside surface; and wherein the elongated base further comprises a void.

In another embodiment, the elongated base has a slit that extends from the outside of the elongated base to the gap.

In one form, the present disclosure provides a method of installing an electric deterrent device, comprising the steps of applying an adhesive between a bottom layer of the electric deterrent device and an external surface; and pressing the electric deterrent device towards the external surface such that an anchor of the electric deterrent device is pressed into the adhesive; wherein the electric deterrent device comprises an elongated base having a cross section including a top layer with a top surface and a bottom surface, and the bottom layer, a first conductive element extending perpendicular to the cross section along the top surface of the top layer, a first fastener that couples the first conductive element to the top surface at a first connection point and extends from the first conductive element through the top layer to a second connection point on the bottom surface of the top layer, and the anchor protruding down from the bottom surface of the top layer, wherein the bottom layer insulates the first fastener at the second connection point from an exterior; wherein the elongated base further comprises at least one void.

In some embodiments, the pressing step further comprises pressing the electric deterrent device towards the external surface such that the adhesive pushes a flap on a side of the anchor upwards as the electric deterrent device is pressed into the adhesive. In another embodiment, the adhesive enters a space between the anchor and the flap as the electric deterrent device is pressed towards the external surface. In another embodiment, the adhesive is squeezed in a direction away from the anchor during the pressing step. In yet another embodiment, a portion of the anchor proximate to its bottom is thicker than a portion of the anchor further from its bottom. In certain embodiments, the anchor is an inverted T shape. In another embodiment, the anchor further comprises a ridge wherein the adhesive is disposed on a top surface of the ridge after the pressing step. In yet another embodiment, the first conductive element and a second conductive element coupled to the top surface of the top layer are attachable respectively to the positive and negative terminals of a power source.

In one form, the present disclosure provides a method of installing an electric deterrent device, comprising the steps of applying an adhesive between a bottom layer of the electric deterrent device and an external surface; and pressing the electric deterrent device towards the external surface such that an anchor of the electric deterrent device is pressed into the adhesive; wherein the electric deterrent device comprises an elongated base having a gap forming a top inside surface and a bottom inside surface, a first conductive element coupled to an outside of the elongated base by a first fastener that extends through to the top inside surface, a second conductive element coupled to an outside of the elongated base by a second fastener that extends through to the top inside surface, and the anchor protruding down from the top inside surface; wherein the elongated base further comprises at least one void.

In one form, the present disclosure provides a process for producing an electric deterrent device, the process comprising the steps of forming an elongated base having a cross section including a top layer with a top surface and a bottom surface, a bottom layer, and at least one void; cutting the elongated base to create a first slit, where the first slit is positioned such that it creates a flap; folding the flap to obtain access to the bottom side of the top layer; and fastening a first conductive element to the top side of the top layer with a first fastener, such that the first fastener extends from the first conductive element to the bottom side of the top layer.

In another embodiment, the process further comprises the step of sealing the first slit. In another embodiment, the first slit is sealed with an adhesive. In yet another embodiment, the cutting step is performed by a first blade creating the first slit; and a second blade creating a second slit. In another embodiment, the first slit and the second slit are made at the same time. In yet another embodiment, the first blade is parallel to the second blade. In another embodiment, the first blade and the second blade are angled towards each other.

In some embodiments, the forming step is performed by extruding the elongated base. In another embodiment, the first slit is cut in the bottom layer. In another embodiment, the first slit is cut in the top layer.

In one form, the present disclosure provides a process for producing an electric deterrent device, the process comprising the steps of forming a top layer of an elongated base, wherein the top layer has a bottom side and a top side; forming a bottom layer of an elongated base; fastening a first conductive element to the top side of the top layer with a first fastener at a first connection point, such that the first fastener extends from the first conductive element to a second connection point on the bottom side of the top layer; and coupling the bottom layer to the bottom side of the top layer. In another embodiment, the bottom layer insulates the first fastener at the second connection point from an exterior. In yet another embodiment, the bottom layer is coupled to the top layer by an adhesive. In another embodiment, the bottom layer is coupled to the top layer by stitching. In some embodiments, the forming steps are performed by extrusion.

In one form, the present disclosure provides an electric deterrent device, comprising an elongated base having a cross section including a top layer with a top surface and a bottom surface, and a bottom layer; a first conductive element extending perpendicular to the cross section along the top surface of the top layer; a first fastener that couples the first conductive element to the top surface at a first connection point and extends from the first conductive element through the top layer to a second connection point on the bottom surface of the top layer; wherein the cross section of the elongated base has a slit in an exterior surface of the elongated base such that the slit creates a flap in the bottom layer of the elongated base where the flap helps insulate the first fastener at the second connection point from moisture or bird excrement, and where there is at least one gap between the bottom surface of the top layer and a top surface of the bottom layer; and wherein the elongated base further comprises at least one void extending along the length of the elongated base.

In another embodiment, the at least one void contains an adhesive, an aerogel, or a foam. In another embodiment, the at least one gap contains an adhesive, an aerogel, or a foam. In some embodiments, the first conductive element is made of a metal. In some embodiments, the conductive element is a conductive plastic. In another embodiment, the first conductive element is coupled to conductive polymer. In some embodiments, the first conductive element is conductive polymer. In another embodiment, the first conductive element is comprised of at least one electrically conductive strand.

In one form, the present disclosure provides an electric deterrent device, comprising an elongated flexible electrically non-conductive base having a void forming a top inside surface and a bottom inside surface; a first electrically conductive element coupled to an outside of the elongated base; a second electrically conductive element coupled to an outside of the elongated base; and where the first electrically conductive element is at least partially comprised of a conductive polymer.

In another embodiment, the first electrically conductive element is at least partially comprised of a metal. In some embodiments, the first electrically conductive element that is at least partially comprised of a metal is coated with a conductive polymer. In another embodiment, the at least one void contains an adhesive, an aerogel, or a foam.

These and other objects, features, aspects, and advantages of the present patent document will become better understood with reference to the following description and accompanying drawings.

### BRIEF DESCRIPTION OF THE DRAWINGS

FIG. 1 illustrates a perspective view of one preferred embodiment of the present patent document.

FIG. 2 illustrates a vertical cross sectional view of one embodiment of the preferred electric deterrent device of FIG. 1.

FIG. 3 illustrates a vertical cross sectional view of one embodiment of the preferred electric deterrent device of FIG. 1 with pieces of the bottom layer folded outward.

FIG. 4 illustrates a vertical cross sectional view of an alternative embodiment of an electric deterrent device of the present patent document where the bottom layer is ridged to increase the bottom surface area of the elongated base.

FIG. 5 illustrates a vertical cross sectional view of an alternative embodiment of an electric deterrent device of the present patent document where the electric deterrent device further comprises a plurality of voids.

FIG. 6 illustrates a vertical cross sectional view of an alternative embodiment of an electric deterrent device of the present patent document where the electric deterrent device further comprises a single gap.

FIG. 7 illustrates a vertical cross sectional view of an alternative embodiment of an electric deterrent device of the present patent document where the electric deterrent device further comprises slits positioned vertically and horizontally in the cross section to create the flaps.

FIG. 8 illustrates a vertical cross sectional view of an alternative embodiment of an electric deterrent device of the present patent document where the electric deterrent device further comprises protrusions of the flaps that help to isolate the fasteners at the second connection point from an exterior.

FIG. 9 illustrates a vertical cross sectional view of an alternative embodiment of an electric deterrent device of the present patent document where the electric deterrent device further comprises a slit in the base.

FIG. 10 illustrates a vertical cross sectional view of an alternative embodiment of an electric deterrent device of the present patent document where the electric deterrent device further comprises protrusions of the flaps, where the protrusions are ball and stem shapes.

FIG. 11 illustrates a vertical cross sectional view of an alternative embodiment of an electric deterrent device of the present patent document where the electric deterrent device further comprises protrusions of the flaps, where the protrusions are arrow shapes.

FIG. 12 illustrates a vertical cross sectional view of an alternative embodiment of an electric deterrent device of the present patent document where there is a slit between the top layer and bottom layer.

FIG. 13 illustrates a vertical cross sectional view of an alternative embodiment of an electric deterrent device of the present patent document where the slit is toward the edge of the gap.

### DETAILED DESCRIPTION OF THE EMBODIMENTS

Reference will now be made to the drawings in which the various elements of the present disclosure will be given numerical designations and in which the present disclosure will be discussed so as to enable one skilled in the art to make and use the present disclosure. It is to be understood that the following description is only exemplary of the principles of the present disclosure, and should not be viewed as narrowing the claims. Additionally, it should be appreciated that the components of the individual embodiments discussed may be selectively combined in accordance with the teachings of the present disclosure. Furthermore, it should be appreciated that various embodiments will accomplish different objects of the present disclosure, and that some embodiments falling within the scope of the present disclosure may not accomplish all of the advantages or objects which other embodiments may achieve.

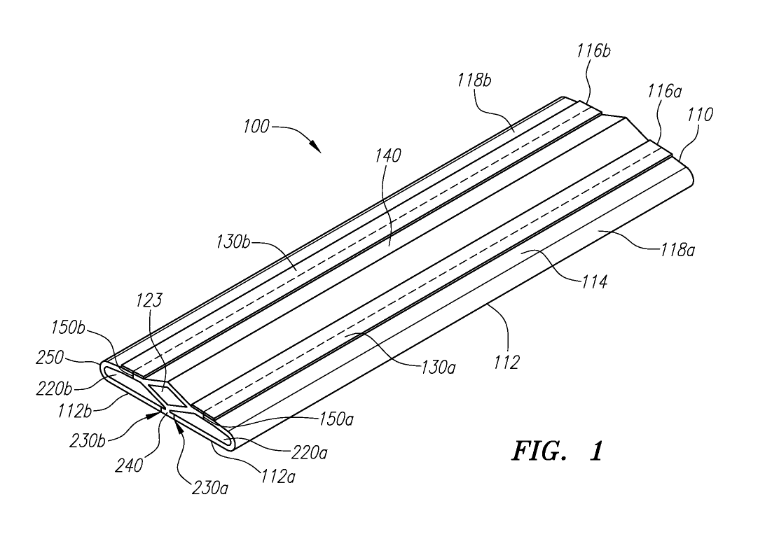

FIG. 1 illustrates a perspective view of a preferred embodiment of the present patent document. In a preferred embodiment, the electric deterrent device includes an elongated base 110 and a pair of conductive elements 130a and 130b attached thereto. In various embodiments, the elongated base 110 may be a variety of different shapes. It should be understood that only those specific elements of the shape of the elongated base 110 described in the claims limit the embodiments claimed.

The elongated base 110 comprises a bottom layer 112 that may be attached to the exterior surface of the location from which the pests or birds are to be deterred. The elongated base 110 comprises a top layer 114. In some embodiments the top layer 114 includes horizontal or angled surfaces 116a and 116b where the conductive elements 130a and 130b are coupled to the elongated base 110. In the embodiment shown in FIG. 1, the conductive elements 130a and 130b are separated by an arc suppressor 140. In this embodiment, the shape of the elongated base is an elongated extrusion with a substantially flat top layer 114 and bottom layer 112, but any shape of the elongated base 110 may be used. The conductive elements 130a and 130b are shown to be rectangular shapes, but round or other shapes may be used as well. The elongated base 110 may also be referred to herein as a base, as an elongated extrusion, or as an extrusion. In other embodiments, the elongated base 110 may either be made from a conductive element, or contain a conductive element. The electric deterrent device may be attached to the surface of the location from which the pests or birds are to be deterred by many different methods, including but not limited to staples, adhesive, nails, pins, tacs, adhesive, screws, nuts and bolts, or a combination thereof, as well as many others. In a preferred embodiment, glue is applied along the center of the bottom of elongated base 110 as a strip or bead in the axial direction. In another embodiment, the glue is applied intermittently along the center of the bottom of the elongated base 110. The device may have angled or sloped portions on its top layer 114 so that in the case of rain or water or other liquid, the liquid will run away down the sloping sides, and will not collect on or about the conductive elements. The elongated base 110 may be made by extrusion, casting thermoforming, molding, or by any other method.

In FIG. 1, the dotted line extending down the middle of the conductive elements 130a and 130b represents the fasteners 150a and 150b such as a stitch or staple. Generally speaking, any fastener may be used to couple the conductive elements 130a and 130b to the elongated base 110. In a preferred embodiment, a stitch or staple is used as a fastener. In other embodiments, other fasteners may include nails, pins, tacs, adhesive, screws and nuts and bolts to name a few.

The electric deterrent device 100 has an elongated base 110 that has a cross section including a top layer 114 with a top surface and a bottom surface, and a bottom layer 112. A first conductive element 130a extends perpendicular to the cross section along the top surface of the top layer 114, and a first fastener 150a that couples the first conductive element 130a to the top surface at a first connection point and extends from the first conductive element 130a through the top layer to a second connection point on the bottom surface of the top layer 114, wherein the flaps 112a and 112b as described in U.S. patent application Ser. Nos. 13/533,846, 13/533,903, 13/533,923, and 13/774, 241 all of which are titled “ANIMAL DETERRENT DEVICE WITH INSULATED FASTENERS” all of which are herein incorporated by reference in their entirety, insulate the first fastener 150a at the second connection point from an exterior (not shown). The flaps 112a and 112b isolates or insulates the fasteners 150a and 150b at their second connection point from water, moisture, or bird excrement that may pool at the bottom of the device. The top layer 114 has a top surface and a bottom surface. The top surface of the top layer 114 may be referred to as a top side. The bottom surface of the top layer 114 may be referred to as a bottom side. The bottom layer 112 has a top surface and a bottom surface. The top surface of the bottom layer 112 may also be referred to as a top side. The bottom surface of the bottom layer 112 may also be referred to as a bottom side.

In some embodiments, the device may further contain a void 123. In other embodiments the device may contain a plurality of voids 124. In some embodiments, a void may extend along the length of the elongated base in the axial direction. In other embodiments, a void 123 may divided into multiple voids by being either substantially or completely closed off at certain points, such as by the non-conductive material of the elongated base during manufacturing of the base, or by for example, a clamp, screw, nail, or weight placed on the device, possibly during use. In some embodiments, a void may be any size and shape. In some embodiments, a void may be as thin as a slit. In some embodiments, a void may be open at the axial ends of the elongated base. In other embodiments, a void may be closed at the axial ends of the elongated base. In some embodiments, a plurality of voids may extend perpendicular to the cross section of the elongated base. In some embodiments, voids may be entirely enclosed within the base. In other embodiments, voids may be partially enclosed within the base. In some embodiments, voids may connect to other voids. In some embodiments, the fasteners may penetrate the voids. In other embodiments, the fasteners do not penetrate any void 123 or voids 124. In some embodiments, the voids may be sealed off from an exterior. In some embodiments, the voids may be sealed by any means, including, but not limited to, by gluing, clamping, heat-melting, or any other method. A void 123 or a plurality of voids 124 may have benefits that include reducing the material used in the manufacturing of the elongated base of the device, thereby reducing cost and weight. The addition of a void 123 or voids 124 in the base may also increase flexibility of the device.

In some embodiments, a material may be added to the void 123 or the voids 124 to help maintain the shape of the device. In some embodiments, at least a portion of a void may include a low-density material, such as a foam or aerogel. In some embodiments where the fasteners 150a and 150b penetrate a void, a material can be added to the void, such as an adhesive such as glue, a foam, or an aerogel, to further help prevent water, moisture, or bird excrement from wicking up a fastener to the conductive element. In some embodiments, the fasteners 150a and 150b may be made of a waterproof or water resistance material such as plastic so as to help prevent water-wicking.

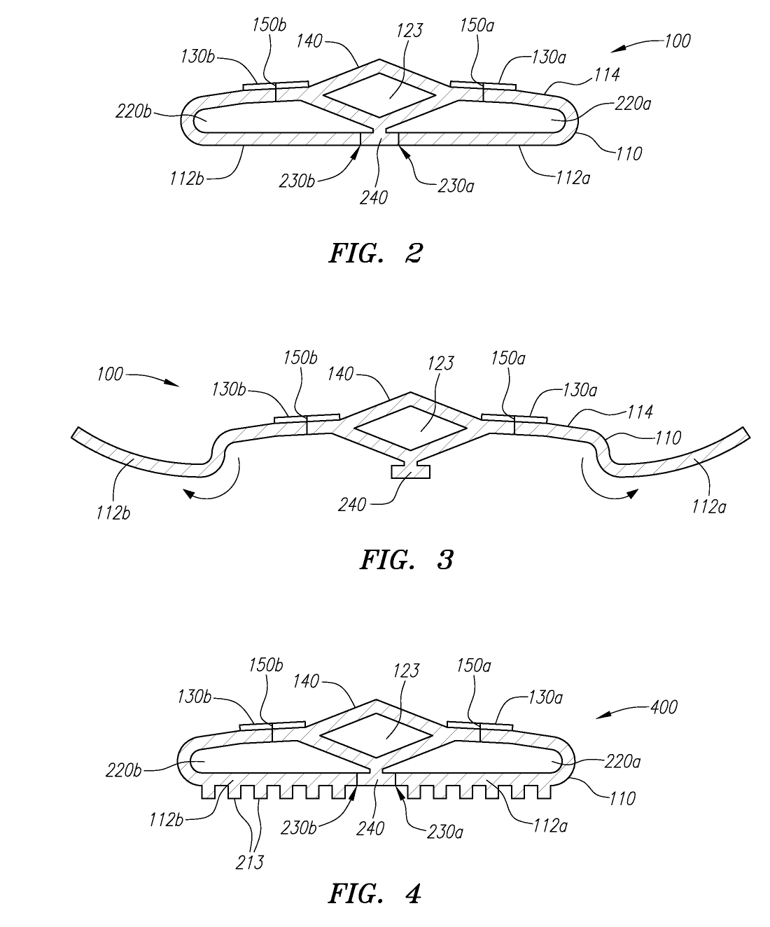

FIG. 2 illustrates a vertical cross sectional view of one embodiment of a preferred electric deterrent device 100 of FIG. 1. In a preferred embodiment of the electric deterrent device, the conductive elements 130a and 130b are braided, such as the braided elements described in U.S. Pat. No. 7,481,021 titled “ELECTRIC DETERRENT DEVICE” which is herein incorporated by reference in its entirety, but they may also be knitted, mesh, interlocking loops, or other configurations. In some embodiments the conductive elements 130a and 130b may be conductive strips or sheets with no free spaces within. In some embodiments, the conductive elements 130a and 130b may contain free spaces within the conductive elements. In embodiments that contain free spaces within the conductive elements it is preferable that the fasteners attach the conductive elements to the base through the free spaces of the conductive elements, preferably without breaking the material of the conductive element. For example, when the fasteners are thread sewing the conductive elements to the base, it is preferable that the thread is sewn through the free spaces, preferably to not pierce and thereby break the material of the conductive elements, which could cause portions of the conductive elements to be pushed into or through the base. In some embodiments, the first conductive element may comprise a braided wire, wherein the braided wire comprises some strands of a conductive material and other strands of a non-conductive material. The conductive elements 130a and 130b are coupled to the elongated base 110 with fasteners 150a and 150b. In a preferred embodiment, the fastener may be a stitch or series of stitches that couple the conductive elements 130a and 130b to the elongated base 110. This type of coupling may be referred to as sewing. The conductive element 130a may be referred to as the first conductive element, and the conductive element 130b may be referred to as the second conductive element. The fastener 150a may be referred to as a first fastener, and the fastener 150b may be referred to as a second fastener. In some embodiments, the first conductive element may further comprise a braided wire. In some embodiments, such as in ones comprising a braided wire, the wire strands that comprise the conductive element may be comprised of some strands of a conductive material and other strands of a non-conductive material. FIG. 2 also shows the cross sectional view of void 123. In the embodiment shown in FIG. 2, the void 123 is open ended and extends along the axial length of the device 100 and perpendicular to the cross section of the base.

The elongated base 110 includes gaps 220a and 220b. In one method of manufacturing the elongated base 110, gaps 220a and 220b are created below the conductive elements 130a and 130b during the formation process. In one embodiment, the elongated base 110 is made by extrusion. In the embodiment shown in FIG. 1, slits 230a and 230b are cut into the bottom layer 112, creating flaps 112a and 112b. In this embodiment, the slits 230a and 230b extend from an exterior through the bottom layer 112 into the gaps 220a and 220b. The flaps 112a and 112b serve to separate or insulate the fasteners 150a and 150b from an exterior. An exterior may be anything that is not part of the electric deterrent device 100. The exterior may include any exterior surface that the base 110 of the electric deterrent device 100 may be attached to.

Slits 230a and 230b allow the bottom layer 112 of the elongated base 110 to fold outward away from the gaps 220a and 220b exposing the inside of the elongated base 110 and the bottom side of the top layer 114. The slits 230a and 230b may be made at any locations of the elongated base 110, including the bottom layer, the top layer, or the sides or edges. In different embodiments different numbers of slits may be used. A slit may be a gap of any width. A gap may also be any size, even as thin as a slit. A slit may be any shape. A gap may also be any shape. In one embodiment, the gaps 220a and 220b in an end of the elongated base 110 may be sealed off from the exterior. The gaps may be sealed by any means, including, but not limited to, by gluing, clamping, heat-melting, or any method that prevents water or other material that could undesirably short circuit the electric deterrent device from entering the gaps.

FIG. 3 illustrates a cross section of one embodiment of the electric deterrent device 100 with portions of the bottom layer 112 in a position bent outward from the device. In the embodiment shown in FIG. 3, the edges of the gaps 220a and 220b are made of a material flexible enough to allow a portion of the bottom layer 112 to be bent outward enough to expose the inside of the top layer 114 of the elongated base 110. The portions of the bottom layer 112 of the elongated base 110 that are bent outward in FIG. 7 are flaps 112a and 112b.

In a preferred embodiment, it is desirable to fold a portion of the bottom layer 112 away from the gap so that the conductive element may be fastened to the top layer 114 more easily. Folding the bottom layer 112 away from the gap may also prevent the fasteners 150a and 150b from accidentally being coupled to the bottom layer 112 when coupling the conductive element to the top layer 114.

In a preferred process for coupling the conductive elements 130a and 130b to the electric deterrent device 100, the bottom layer 112 is unfolded outward to allow the conductive elements 130a and 130b to be fastened to the top layer 114 of the elongated base 110, while preventing the fasteners 150a and 150b from penetrating the bottom layer 112 of the elongated base 110. The flaps 112a and 112b may then be folded back into place after the conductive elements 130a and 130b are attached, insulating the fasteners 150a and 150b from the exterior. In a preferred embodiment, the bottom layer 112 provides insulation for the fasteners 150a and 150b that may penetrate through the bottom side of the top layer 114 by preventing rain, water, other liquid, animal waste (such as bird excrement), or other material that may pool underneath the elongated base 110 from traveling through any holes made in the top layer 114 during fastening or being absorbed by the fasteners 150a and 150b, thereby preventing an undesired short circuit in the electric deterrent device 100. The bottom layer 112 also provides insulation for conductive elements 130a and 130b that may have been pushed through the top layer 114 in the fastening process, such as by a needle pushing a portion of a conductor through the bottom surface of the top layer 114. In some embodiments, after the conductive elements 130a and 130b have been attached, the flaps 112a and 112b may subsequently be secured back into place with an adhesive such as glue, thereby further insulating any portion of the fasteners 150a and 150b that pushed through the top layer 114 of the elongated base 110 from the exterior, and thus preventing arcing to the exterior surface below. In a preferred embodiment, it may be desirable to have the adhesive act as an additional insulator for the fasteners 150a and 150b against an exterior environment. In other embodiments, the flaps 112a and 112b may be secured by other methods, including, but not limited to, screws, bolts, staples, nails, or any other method as long as the flaps 112a and 112b insulate the connection points of the fasteners 150a and 150b from an exterior.

During one embodiment of the manufacturing process, a portion of the bottom layer 112 that is folded away from the gap may be held in place in the configuration of FIG. 3 either by an operator or by some mechanical device or other means. While the flaps 112a and 112b are folded away, the conductive elements 130a and 130b are coupled to the elongated base 110 with fasteners 150a and 150b. As a result, in this embodiment, the fasteners 150a and 150b just extend through the top layer 114.

In some embodiments, an adhesive or glue may be applied to an area inside the gaps 220a and 220b. In one embodiment, the adhesive applied inside the gap further insulates the fasteners 150a and 150b so that when the portion of the elongated base 110 that was folded away during manufacturing is released and retakes its former position at the bottom layer 112 of the elongated base 110, the fasteners 150a and 150b are then insulated by both the adhesive and the bottom of the elongated base 110 from the exterior. In some embodiments, only a portion of the gap is filled with adhesive while in other embodiments the entire gap may be filled or substantially filled. In another embodiment, the adhesive may be applied to the portion of the fasteners 150a and 150b that protrude into the gap.

In some embodiments, the elongated base 110 may include notches, grooves, channels, or holes on the bottom surface of the bottom layer of the device 100 to help in mounting the electric deterrent device 100 to the desired surface. In some embodiments, these notches, grooves, channels, or holes may be either completely filled or partially filled with an adhesive such as glue. In yet other embodiments, the elongated base 110 may be mechanically attached to a desired surface. In such embodiments, attachment may be facilitated by screws, bolts, staples, nails, or any mechanical fastener. In some embodiments both adhesives and mechanical fasteners 150a and 150b may be used to attach the elongated base 110 to a desired surface. In certain embodiments, a center point reference mark 260 may be included in the elongated base 110. In other embodiments, no center point reference mark may be used.

The dimensions of a preferred embodiment will now be recited. These dimensions represent the dimensions of one preferred embodiment by way of example, and other embodiments may have other dimensions. In a preferred embodiment, the elongated base 110 is approximately 1.5 inches wide and approximately 0.36 inches high (from the bottom layer 112 to the top layer 114 of the arc suppressor 140). These dimensions are by way of illustration only. The dimensions may be varied in any fashion as appropriate to the application. As just one example, the dimensions may be varied to accommodate different size birds or other pests. Also, the length of the electric deterrent device 100 segment as illustrated is relatively short. However, the elongated base 110 may be constructed in any length, and is preferably constructed in as long a length as feasible so as to avoid inter-connecting segments of the electric deterrent device 100. For example, in one embodiment, the electric deterrent device 100 may be 50 feet long. However, inter-connecting segments of the electric deterrent device to form an elongated base of greater length than any individual segment may be used as well. In a preferred embodiment, the electric deterrent device 100 may be curved without harming its performance or life-expectancy. Accordingly, it may be rolled for shipment and storage, thus allowing for much longer single-formed pieces.

The electric deterrent device may include a center divider 240. The center divider 240 helps to prevent unwanted short circuiting, particularly in some embodiments where the axial ends of the electric deterrent device are left open or where water or other material that may cause a short circuit enters a gap. In other embodiments, a divider may be in other locations besides the center of the cross section, provided that it separates the first fastener 150a from the second fastener 150b. In other embodiments, no center divider 240 may be included, resulting in a single gap 222 as shown, for example, in FIG. 6 below.

In some embodiments, the center divider 240 may be referred to as an anchor.

The anchor may also be referred to as a glue anchor, a glue lock, or glue spine. In some embodiments, the anchor may further comprise an area proximate to its bottom that has a greater width than other locations along its length. In some embodiments, the center divider 240 may be an inverted T-shape. The inverted T-shape operates as an anchor, creating a greater surface area for the adhesive 160 to grip. In a preferred embodiment, the anchor may be embedded into the adhesive. In another embodiment, the anchor further comprises a ridge wherein the adhesive is disposed on a top surface of the ridge after the pressing step. In one embodiment, during installation, the anchor embeds itself into the adhesive, and when the electric deterrent device is pressed toward an exterior surface, the remaining adhesive works its way towards the edges of the electric deterrent device, ensuring a tight grip. The adhesive may be applied to the bottom layer 112, or to the external surface. In a preferred embodiment, where the anchor is located in the center of the electric deterrent device, such as in FIG. 2, the adhesive is applied to the center of the electric deterrent device. In some embodiments, the adhesive may be applied to other portions of the bottom of the device, such as in a zigzag pattern covering portions of the center and portions of areas under the flaps, or in patches along the axial length of the bottom of the device. In some embodiments, the adhesive 160 may be glue. In some embodiments, the anchor may be located in the center of the electric deterrent device as in FIG. 2. In one embodiment, the anchor may have an upward facing surface substantially parallel to the bottom layer 112 such as shown in FIG. 2. In another embodiment, the anchor may be a shape with an upward facing surface that is angled. The anchor may be any shape such that the anchor has a greater surface area such that an adhesive can adhere to.

FIG. 4 illustrates yet another embodiment of an electric deterrent device of the present patent document. The embodiment of electric deterrent device 400 of FIG. 4 is similar to the embodiment of FIG. 2 except that the bottom layer 112 has ridges 213 to increase the bottom surface area of the elongated base 110. In FIG. 4 a surface area of the bottom surface of the bottom layer 112 is increased over a substantial portion of the bottom surface of the bottom layer. The ridges 213 preferably extend axially along the length of the elongated base 110. An adhesive may be applied between the ridged bottom surface of the bottom layer 112 and an exterior surface, such that the glue has a greater surface area to adhere to on the elongated base 110, than if there were a flat base as in some of the other embodiments shown herein. In some embodiments, though the ridges 213 increase the surface area of the bottom surface of the bottom layer 112, the ridges 213 should be small enough so that the adhesive used is the minimal amount necessary for maximum adhesion or bonding strength to the exterior surface. As shown in FIG. 4, the ridges 213 cover a substantial portion of the cross-sectional width of the bottom surface of the bottom layer 112. In some embodiments, any number of ridges may be used. The electric deterrent device of FIG. 4 is shown with rectangular ridges 213, but rounded, angled, jagged, or other shapes may be used as long as they increase the surface area of the bottom layer 112. In some embodiments, the ridged pattern may be repeatable shapes. In other embodiments, the bottom surface may have non-repeating shapes. The ridged bottom surface may also be referred to as jagged or toothed. In other embodiments, the bottom surface may be corrugated or ribbed.

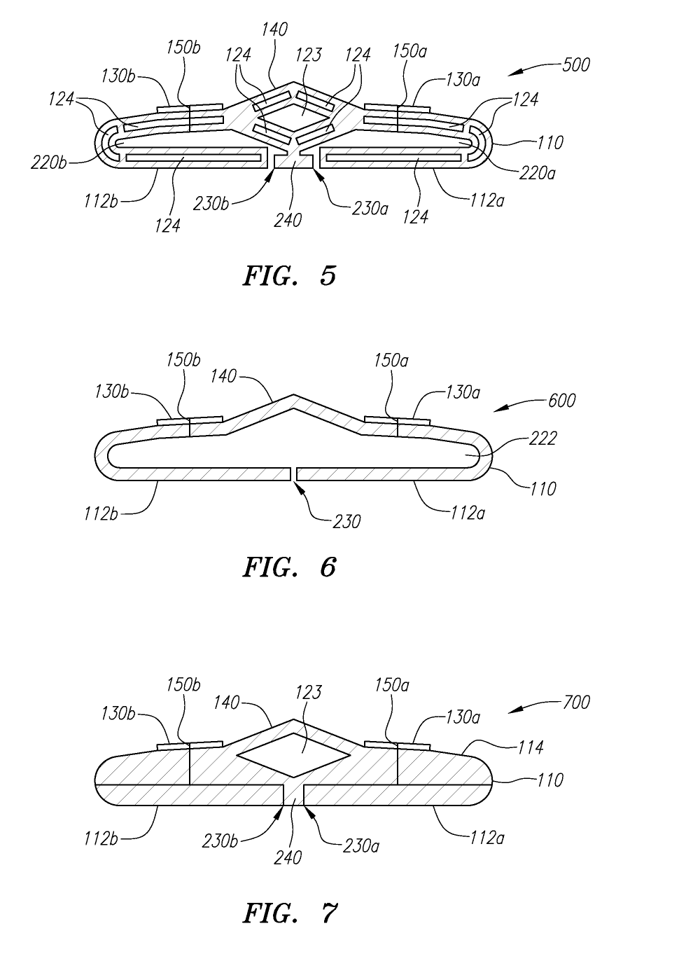

FIG. 5 illustrates a vertical cross sectional view of an alternative embodiment of an electric deterrent device of the present patent document. In the embodiment of electric deterrent device 500 shown in FIG. 5, the elongated base 110 comprises a plurality of voids 124. The voids 124 may be any shape, and may be positioned in area of the device such that they reduce the material used to make the elongated base. In some embodiments the void 123 or voids 124 may be used to increase the flexibility of the base by removing excess material from the base, which may allow for less resistance to bending the device.

FIG. 6 illustrates a vertical cross sectional view of an alternative embodiment of an electric deterrent device of the present patent document. In the embodiment of electric deterrent device 600 shown in FIG. 6, the elongated base 110 comprises a gap 222.

FIG. 7 illustrates a vertical cross sectional view of an alternative embodiment of an electric deterrent device of the present patent document. In the embodiment of electric deterrent device 700 shown in FIG. 7, the elongated base 110 comprises slits 230a and 230b that extend vertically and horizontally in the cross section to create the flaps 112a and 112b. In the embodiment of FIG. 7, when the flaps are in the closed position, such as after manufacturing or during installation, the top surface of the flaps 112a and 112b entirely contact the bottom surface of the top layer 114 as shown in FIG. 7, such that there is no space or effectively no space between the flaps 112a and 112b and the bottom surface of the top layer 114. In other embodiments, the slits 230a and 230b may be oriented in any direction such that they create a flap or multiple flaps in the base. For example, in some embodiments, the slits 230a and 230b may be at opposing 45 degree angles relative to the bottom layer of the cross section.

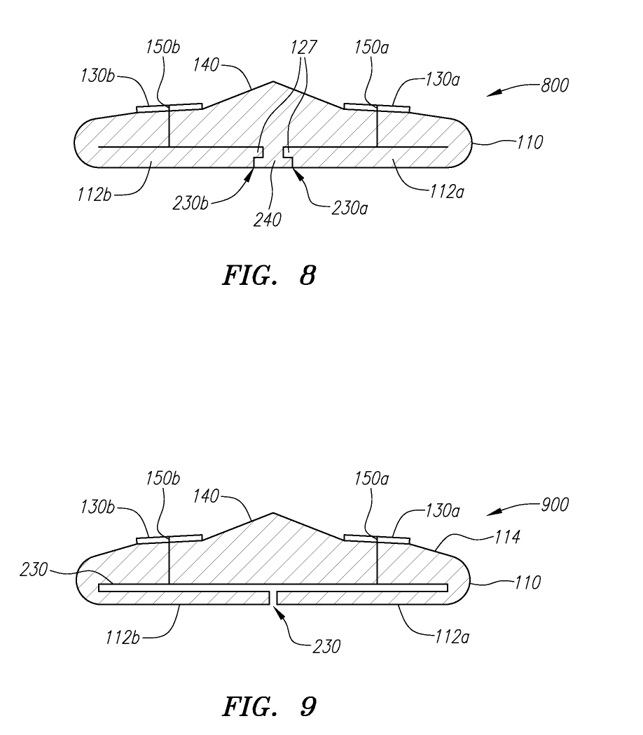

FIG. 8 illustrates a vertical cross sectional view of an alternative embodiment of an electric deterrent device of the present patent document. In the embodiment of electric deterrent device 800 shown in FIG. 8, the elongated base 110 further comprises protrusions 127 of the flaps 112a and 112b that help to isolate the fasteners at the second connection point from an exterior.

FIG. 9 illustrates a vertical cross sectional view of an alternative embodiment of an electric deterrent device of the present patent document. In the embodiment of electric deterrent device 900 shown in FIG. 9, the elongated base 110 comprises a slit 230. In other embodiments, the slit 230 may be oriented in any direction such that it creates a flap or multiple flaps in the base of the device.

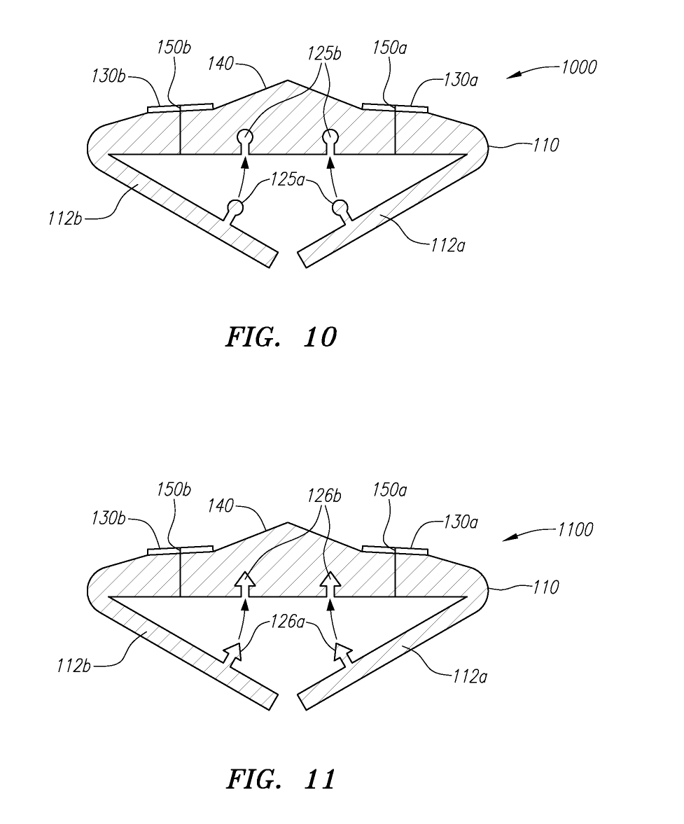

FIG. 10 illustrates a vertical cross sectional view of an alternative embodiment of an electric deterrent device of the present patent document. In the embodiment of electric deterrent device 1000 shown in FIG. 10, the elongated base 110 further comprises protrusions 125a of the flaps 112a and 112b that help to isolate the fasteners at the second connection point from an exterior by interlocking into openings 125b. The protrusions 125a and openings 125b may be any interlocking or interconnecting shapes. In some embodiments, the protrusions 125a and openings 125b do not have to be the same shape, so long as protrusion 125a fits within opening 125b. In FIG. 10, protrusions 125a are a ball with stem shape.

FIG. 11 illustrates a vertical cross sectional view of an alternative embodiment of an electric deterrent device of the present patent document. In the embodiment of electric deterrent device 1100 shown in FIG. 11, the elongated base 110 further comprises protrusions 126a of the flaps 112a and 112b that help to isolate the fasteners at the second connection point from an exterior by interlocking into openings 126b. In FIG. 11, protrusions 126a are an arrow shape.

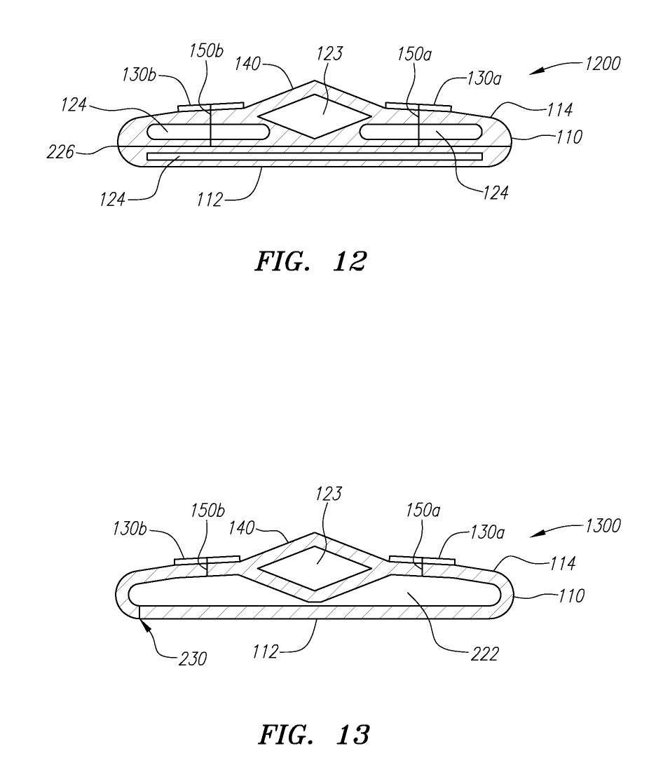

FIG. 12 illustrates yet another embodiment of an electric deterrent device of the present patent document. The embodiment of electric deterrent device 1200 of FIG. 12 has a slit 226 that separates the bottom layer 112 from the top layer 114. This embodiment also allows for the installation of the fasteners 150a and 150b more easily. In the embodiment of FIG. 15, the elongated base 110 further comprises a slit 226 between the first non-conductive piece, the top 114, and the second non-conductive piece, the bottom layer 112, where the two non-conductive pieces are coupled to insulate the fasteners 150a and 150b from the exterior. The slit 226 may also be called a gap. The slit 226 may be any width separating the top layer 114 from the bottom layer 112. The slit 226 may be a gap of any width. The slit 226 may be any shape. The embodiment of FIG. 12 also shows voids in both the bottom layer 112 and the top layer 114. In the embodiment of FIG. 12 the fasteners 150a and 150b extend through the voids 124 in the top layer 114.

FIG. 13 illustrates a vertical cross sectional view of another embodiment of an electric deterrent device of the present patent document. The embodiment of electric deterrent device 1300 shown in FIG. 13 the position of the slit 230 is proximate to an edge of the gap 222. Placing the slit 230 proximate to an edge of the gap 222 allows for the bottom layer 112 to be folded away as one piece instead of two pieces as in other embodiments. The portion of the bottom layer 112 that may be folded away may also be called a flap. In this embodiment, there is also only one gap 222 instead of two gaps as in other embodiments.

In some embodiments, the conductive elements 130a and 130b may be intrinsically conducting polymers, such as for example, polyacetylene, polypyrrole, polyaniline, or their copolymers. The conductive polymer may either be used as the conductive elements 130a and 130b or to partially or completely surround the conductive elements 130a and 130b to provide protection against environmental elements such as water or bird excrement.

The electric deterrent device is preferably attached to the surface of the edge of the building or place where the pests or birds are to be deterred. Attachment may be by any mechanical means such as screw, bolts, staples, nails, an adhesive such as glue, or any other attachment means, or any combination. The elongated base 110 may be of any shape and size as dictated by the specific size and type of animal, bird or pest to be deterred, and the area to which the electric deterrent device is to be installed, so long as the two electrically conductive elements 130a and 130b are kept a sufficient distance apart so as to prevent unwanted short circuiting, and are not so far apart at to not be short-circuited when the intended-to-be deterred animal, pest or bird contacts the electric deterrent device. The elongated base 110 may be constructed of any material so long as there is sufficient non-conductive material immediately adjacent the conductive elements 130a and 130b so as to prevent unwanted short circuiting. In a preferred embodiment, the entire elongated base 110 is made of a single material, in this case extruded polyvinyl chloride that is extremely flexible, durable and UV resistant, and is sufficiently soft so as to allow for the sewing operation whereby the conductive elements 130a and 130b may be sewn directly to the elongated base 110. The elongated base 110 may be constructed of any color so as to blend with the structure to which it will ultimately be attached. It is not necessary that the elongated base 110 be of unitary material and construction. In some embodiments, cellular, flex or rigid polyvinyl chloride may be used as a material for construction of the elongated base 110. In other embodiments, other possible materials for construction of the elongated base 110 may include, but are not limited to, neoprene, fluoroelastomer (available commercially under trademarks Vitron® and Flourel 8), silicone, natural rubber, buna N (nitrile), buna S (SBR), thermoplastic rubber, synthetic polyisoprene, EPDM and polyurethane.

In a preferred embodiment, the conductive elements 130a and 130b are comprised of elongated individual strands that are braided in a length-wise substantially curvilinear fashion. In other embodiments, the conductive elements may be constructed from a mesh comprised of separate warp and weft strands that are arranged in a substantially perpendicular relationship to one another. A few strands of a very strong, albeit non-conductive material might be desired to add even more strength and durability. In some embodiments, a conductive element may be made of metal. While flat braids are preferred, non-flat braided material could also be used. Also, while stainless steel is preferred for the conductive elements, iron, steel, copper, and zinc plated copper are just some examples of many other conductive materials that could be substituted.

The preferred means for attaching the conductive elements 130a and 130b to the elongated base 110 is by sewing, especially where the conductive elements 130a and 130b are braided, mesh, or other interconnected woven configuration. While any suitably durable and string thread may be used in the sewing operation, 100% polyester has proven suitable. A single line of stitching illustrated as fasteners 150a and 150b down the longitudinal center of each conductive element 130a and 130b (best seen in FIG. 5) has proven sufficient, although many other sewing stitches, styles and placement would work as well. As shown in FIG. 5, the fasteners 150a and 150b could also represent staples or any other fastener.

Other attachment means for attaching the conductive elements 130a and 130b to the elongated base 110 could be used instead of or in addition to sewing. For example, the conductive elements 130a and 130b could also be glued or heat-melted to the elongated base 110, or stapled, or bolted, or screwed into place on the elongated base 110. However, it is believed that for ease of construction, for durability, and for attractiveness, sewing is preferred.

In some embodiments, the ends of conductive elements 130a and 130b are attached to the terminals of a conventional power source (not shown). In other embodiments, the conductive elements 130a and 130b may be attached to the terminals of a conventional power source at locations other than at the ends of the conductive elements 130a and 130b through the use of clamps, clips, inserts or other similar ways of connecting conductive elements to a power source. A charge of approximately 800 volts alternating current, at low ampere (10 mA) or 7.5 KV, 3 amp direct current, has proven effective to deter birds. Larger voltages and amperes may be necessary for larger animals. If the desire was to execute the pest rather than simply deter, then the voltages and amperes would have to be increased accordingly, and the current bearing characteristics of the conductive elements 130a and 130b would have to be adjusted accordingly as well. In some embodiments, multiple devices 100 may be placed in a parallel or substantially parallel configuration. In some embodiments, devices 100 placed in parallel configurations may be connected to each other. In some embodiments, devices 100 may be connected to each other by connectors contacting one or more of the conductive elements 130a and 130b. For example, in some embodiments, the conductive element 130a of one device 100, may be connected to the conductive element 130a of a second device 100. In some embodiments, the ends of one device 100 may be connected to a power source, while a second device 100 may be connected to the power source through a connector between the conductive elements of each device 100.

Although the embodiments have been described with reference to the drawings and specific examples, it will readily be appreciated by those skilled in the art that many modifications and adaptations of the apparatuses and processes described herein are possible without departure from the spirit and scope of the embodiments as claimed hereinafter. Thus, it is to be clearly understood that this description is made only by way of example and not as a limitation on the scope of the embodiments as claimed below.

What is claimed is:

1. An electric deterrent device, comprising:
an elongated base having a cross section including a top layer with a top surface and a bottom surface, and a bottom layer;
a first conductive element extending perpendicular to the cross section along the top surface of the top layer;
a first fastener that couples the first conductive element to the top surface at a first connection point and extends from the first conductive element through the top layer to a second connection point on the bottom surface of the top layer;
wherein the cross section of the elongated base has a slit in an exterior surface of the elongated base such that the slit creates a flap in the bottom layer of the elongated base where the flap helps insulate the first fastener at the second connection point from moisture or bird excrement, and where there is at least one gap between the bottom surface of the top layer and a top surface of the bottom layer; and
wherein the elongated base further comprises at least one void extending along the length of the elongated base.

2. The electric deterrent device of claim 1, wherein the at least one void contains an adhesive, an aerogel, or a foam.

3. The electric deterrent device of claim 1, wherein the at least one gap contains an adhesive, an aerogel, or a foam.

4. The electric deterrent device of claim 1, wherein the first conductive element is metal.

5. The electric deterrent device of claim 4, wherein the first conductive element is coupled to conductive polymer.

6. The electric deterrent device of claim 1, wherein the first conductive element is conductive polymer.

7. The electric deterrent device of claim 1, wherein the first conductive element is comprised of at least one electrically conductive strand.

8. An electric deterrent device, comprising:
an elongated flexible electrically non-conductive base having a void forming a top inside surface and a bottom inside surface;
a first electrically conductive element coupled to an outside of the elongated base;
a second electrically conductive element coupled to an outside of the elongated base; and where the first electrically conductive element is at least partially comprised of a conductive polymer.

9. The electric deterrent device of claim 8, wherein the first electrically conductive element is at least partially comprised of a metal.

10. The electric deterrent device of claim 9, wherein the first electrically conductive element that is at least partially comprised of a metal is coated with a conductive polymer.

11. The electric deterrent device of claim 8, wherein the at least one void contains an adhesive, an aerogel, or a foam.
